(19) United States
(12) Patent Application Publication
(10) Pub. No.: US 2020/0013225 A1
(43) Pub. Date: Jan. 9, 2020

(54) VEHICLE EXTERNAL INFORMATION OUTPUT METHOD USING AUGMENTED REALITY AND APPARATUS THEREFOR

(71) Applicant: LG ELECTRONICS INC., Seoul (KR)

(72) Inventors: Jongjin PARK, Seoul (KR); Jichan MAENG, Seoul (KR)

(73) Assignee: LG ELECTRONICS INC., Seoul (KR)

(21) Appl. No.: 16/574,574

(22) Filed: Sep. 18, 2019

(30) Foreign Application Priority Data
Aug. 14, 2019 (KR) 10-2019-0099868

(51) Int. Cl. G06T 19/00; B60W 50/14; G06F 3/01; B60Q 5/00; B60R 11/04; B60W 40/08

(52) U.S. Cl. CPC G06T 19/006; B60W 50/14; G06F 3/013; B60W 2050/146; B60R 11/04; B60W 40/08; B60Q 5/006

(57) ABSTRACT

A vehicle external information output method and an apparatus therefor are disclosed. The vehicle external information output method according to an embodiment of the present invention has the advantageous effect. A DSM camera acquires external information relating to a zone to which a user's gaze is directed. The external information is output to provide the user with a visual field having no blind spot. An autonomous vehicle according to the present invention can be associated with an artificial intelligence module, a drone (unmanned aerial vehicle, UAV), a robot, an augmented reality (AR) device, a virtual reality (VR) device, and a 5G service.

### CROSS-REFERENCE TO RELATED APPLICATION

Pursuant to 35 U.S.C. § 119(a), this application claims the benefit of an earlier filing date and priority to Korean Application No. 10-2019-0099868 filed in the Republic of Korea on Aug. 14, 2019, the contents of which are incorporated by reference herein in its entirety.

### BACKGROUND OF THE INVENTION

### Field of the Invention

The present invention relates to a vehicle external information output method, and more particularly to a method for acquiring vehicle external information and providing the vehicle external information by using augmented reality and an apparatus therefor.

### Discussion of the Related Art

Virtual reality (VR) means any specific environment, situation, or technology itself which is created by an artificial technique using a computer, and which is similar to reality but is not reality. Augmented reality (AR) means a technique for synthesizing virtual things or information with a real environment so that the virtual things or the information look like things in an original environment.

Mixed reality (MR) or hybrid reality means creating a new environment or new information by combining a virtual world and a real world with each other. In particular, the mixed reality is referred to by real-time interaction between really existing things and virtually existing things on a real time basis.

In this case, a created virtual environment or situation stimulates five senses of a user, and allows the user to have a free access to a boundary between reality and imagination by providing the user with a spatial or temporal experience similar to the reality. In addition, the user can be simply immersed in the environment. Moreover, the user can interact with realized things in the environment by using a really existing device to manipulate or instruct the realized things.

Recently, gears used in this technical field have been actively researched. Specifically, since vehicles have been developed and widely distributed, one household actually owns one or more vehicles. Due to the widely distributed vehicles, various types of accidents happen. In particular, many accidents happen since a visual field of a driver is blocked by the vehicle itself (pillar, door, ceiling, or bonnet).

Therefore, it is necessary to minimize inconvenience of the driver which may be caused by such a blind spot when the driver drives the vehicle. Therefore, various methods for providing the driver with an external image relating to a blind spot direction of the vehicle in a form of the augmented reality have been researched.

### SUMMARY OF THE INVENTION

The present invention aims to solve the above-described needs and/or problems.

The present invention also aims to provide a driver with an external image relating to a visual field blocked by a vehicle body.

The present invention also aims to provide an external image of a vehicle by sensing a gaze direction of a driver.

According to an embodiment of the present invention, there is provided a vehicle external information output method. The method includes: sensing a gaze direction of a driver through a driver status monitoring (DSM) camera installed in a vehicle; confirming whether the gaze direction of the driver is directed to a first zone in a plurality of preset zones; acquiring an external image of the first zone through a first device installed in the vehicle, in a case where the gaze direction of the driver is directed to the first zone; sensing whether an obstacle is present in the external image of the first zone; and outputting at least any one of the external image of the first zone and information relating to the obstacle in the external image of the first zone, to the first zone through a second device installed in the vehicle. The plurality of preset zones include a remaining element excluding a transparent element in a plurality of elements configuring an exterior of the vehicle, and that block a gaze of the driver, the second device is any one of smart glasses, a projector, an external image display, and an indicator, and in a case where the second device is the smart glasses, at least any one of the external image of the first zone and the information relating to the obstacle is output in a form of augmented reality (AR).

The plurality of preset zones may include at least one of a pillar, a door, a ceiling, and a bonnet of the vehicle.

In a case where the second device is the external image display, the external image display may be installed in at least any one of the plurality of preset zones of the vehicle.

Outputting at least any one of the external image of the first zone and the information relating to the obstacle in the external image of the first zone, to the first zone through the second device installed in the vehicle may be outputting the presence of the obstacle through an LED of the indicator in a case where the second device is the indicator and the obstacle is present in the external image of the first zone.

Navigation information may be additionally output to the first zone in the vehicle external information.

The navigation information may include at least any one of a position of the vehicle, a speed of the vehicle, a destination of the vehicle, and an arrival time to the destination of the vehicle.

The information relating to the obstacle in the external image of the first zone may be at least any information among a distance between the obstacle in the external image of the first zone and the vehicle, a moving speed of the obstacle in the external image of the first zone, and a type of the obstacle in the external image of the first zone.

The method may further include stopping at least any one output of the external image of the first zone and the information relating to the obstacle in the external image of the first zone, in a case where the DSM camera detects that the gaze direction of the driver moves from the first zone to a second zone; acquiring the external image of the second zone through the first device; sensing whether the obstacle is present in the external image of the second zone; and outputting at least any one of the external image of the second zone and the information relating to the obstacle in the external image of the second zone, to the second zone. The second zone may be one of the plurality of preset zones.

There is provided a vehicle external information output apparatus. The apparatus includes a driver status monitoring (DSM) camera installed in a vehicle and sensing a gaze direction of a driver; and a processor functionally linked with the DSM camera. The processor controls the DSM camera to detect whether the gaze direction of the driver is directed to a first zone in a plurality of preset zones, the processor controls a first device to acquire an external image of the first zone, in a case where the gaze direction of the driver is directed to the first zone, the processor controls the first device to detect whether an obstacle is present in the external image of the first zone, the processor controls a second device installed in the vehicle to output at least any one of the external image of the first zone and information relating to the obstacle in the external image of the first zone, to the first zone, the plurality of preset zones are zones that include a remaining element excluding a transparent element in a plurality of elements configuring an exterior of the vehicle, and that block a gaze of the driver, the second device is any one of smart glasses, a projector, an external image display, and an indicator, and in a case where the second device is the smart glasses, at least any one of the external image of the first zone and the information relating to the obstacle is output in a form of augmented reality (AR).

The plurality of preset zones may include at least one of a pillar, a door, a ceiling, and a bonnet of the vehicle.

In a case where the second device is the external image display, the external image display may be installed in at least any one of the plurality of preset zones of the vehicle.

In a case where the second device is the indicator and the obstacle is present in the external image of the first zone, the presence of the obstacle may be output through an LED of the indicator.

The second device may additionally output navigation information to the first zone.

The navigation information may include at least any one of a position of the vehicle, a speed of the vehicle, a destination of the vehicle, and an arrival time to the destination of the vehicle.

The information relating to the obstacle in the external image of the first zone may be at least any information among a distance between the obstacle in the external image of the first zone and the vehicle, a moving speed of the obstacle in the external image of the first zone, and a type of the obstacle in the external image of the first zone.

In a case where the DSM camera detects that the gaze direction of the driver moves from the first zone to the second zone, the processor may control the second device to stop at least any one output operation of the external image of the first zone and the information relating to the obstacle in the external image, the processor may control the first device to acquire the external image of the second zone, the processor may control the first device to detect whether the obstacle is present in the external image of the second zone, the processor may control the second device to output at least any one of the external image of the second zone and the information relating to the obstacle in the external image of the second zone, to the second zone, and the second zone may be one of the plurality of preset zones.

There is provided an electronic device including: one or more processors; a memory; and one or more programs. The one or more programs are stored in the memory, are executed by the one or more processors, and the one or more programs include a command for executing the vehicle external information output method.

### BRIEF DESCRIPTION OF THE DRAWINGS

The accompanying drawings, which are included as part of the detailed description to help understand the present invention, provide an embodiment of the present invention. In addition, the drawings show the technical features of the present invention together with the

### DETAILED DESCRIPTION

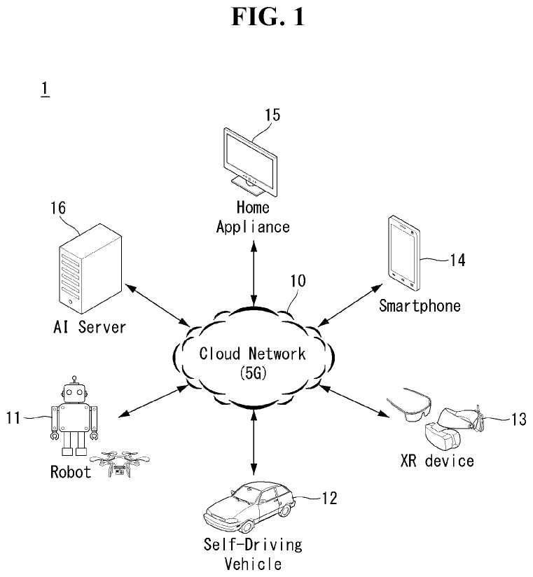

FIG. 1 illustrates one embodiment of an AI device.

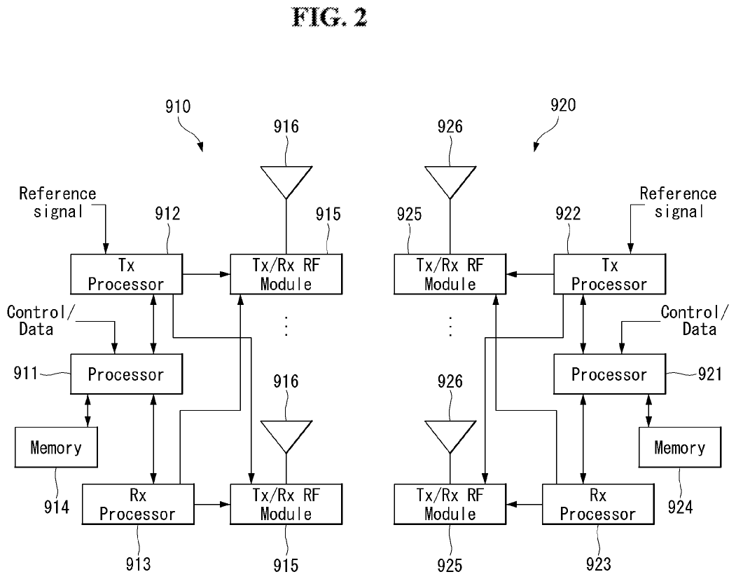

FIG. 2 illustrates a block diagram of a wireless communication system to which the methods proposed herein may be applied.

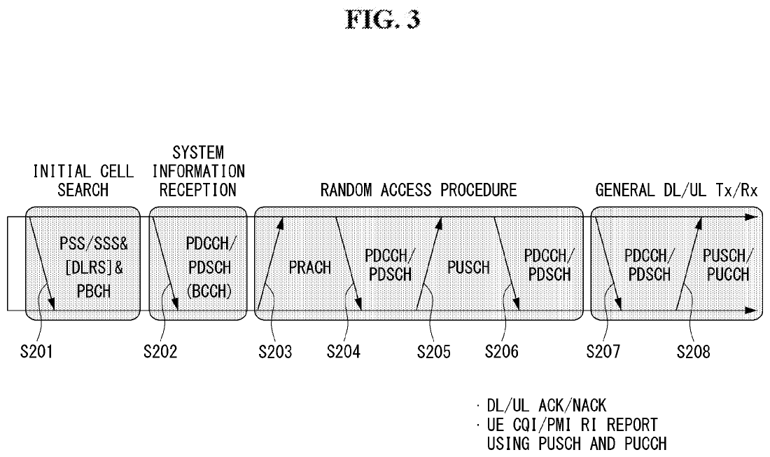

FIG. 3 illustrates an example of a signal transmission/reception method in a wireless communication system.

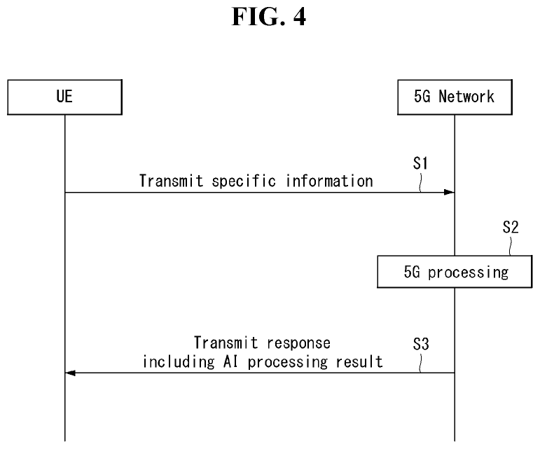

FIG. 4 illustrates an example of basic operations of a user terminal and a 5G network in a 5G communication system.

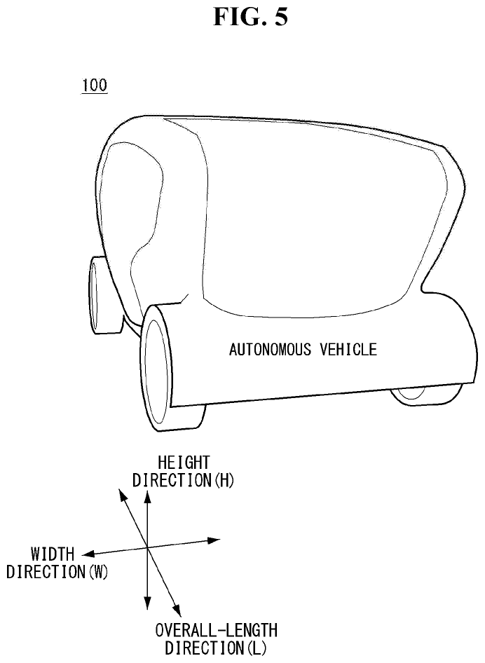

FIG. 5 shows a vehicle according to an embodiment of the present invention.

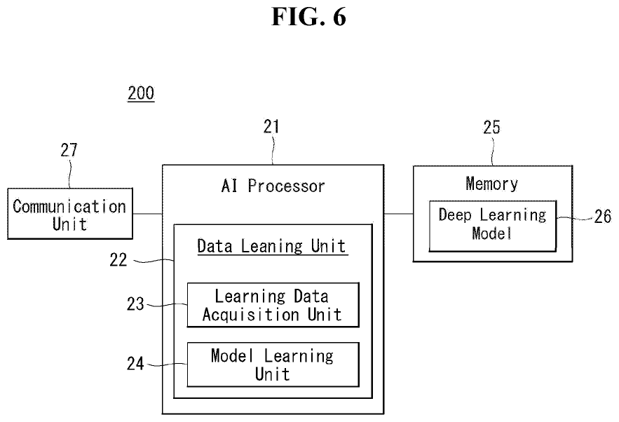

FIG. 6 is a block diagram illustrating an AI device according to an embodiment of the present invention.

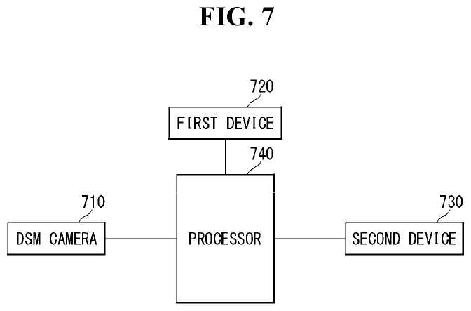

FIG. 7 is a block diagram of a vehicle external information output apparatus proposed in the present disclosure.

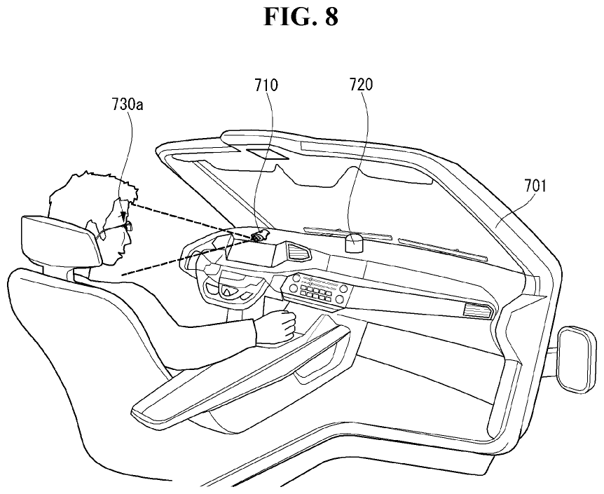

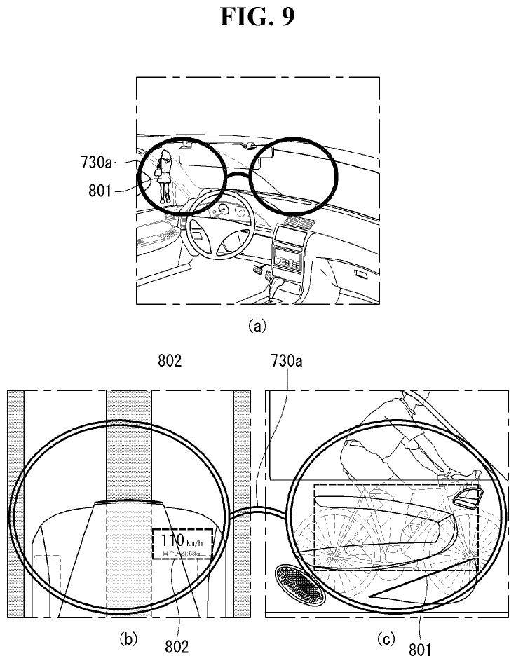

FIGS. 8 and 9 show an example in which vehicle external information is output through smart glasses proposed in the present disclosure.

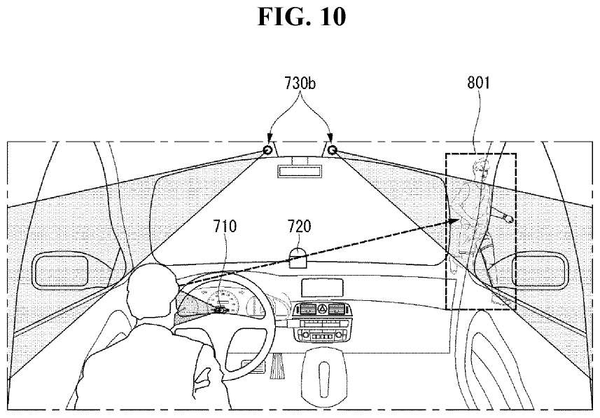

FIG. 10 shows an example in which the vehicle external information is output through a projector proposed in the present disclosure.

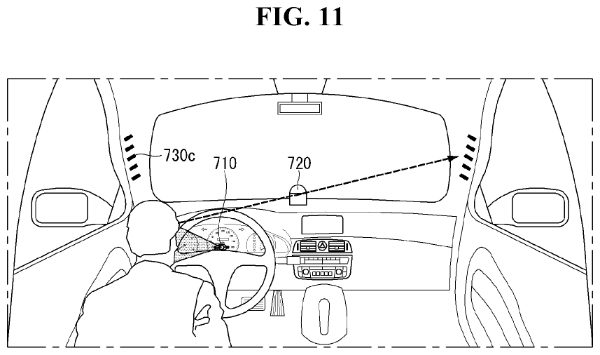

FIG. 11 shows an example of the vehicle external information output proposed in the present disclosure.

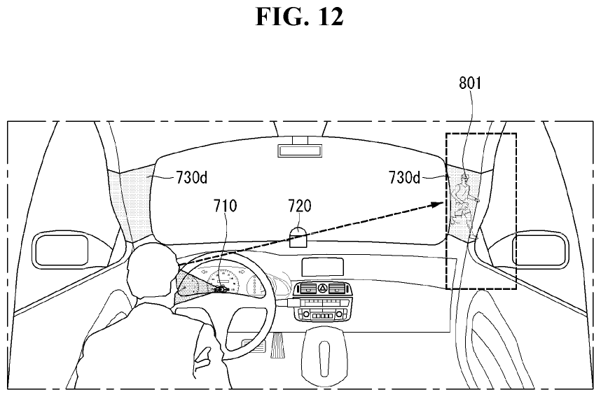

FIG. 12 shows an example of the vehicle external information output proposed in the present disclosure.

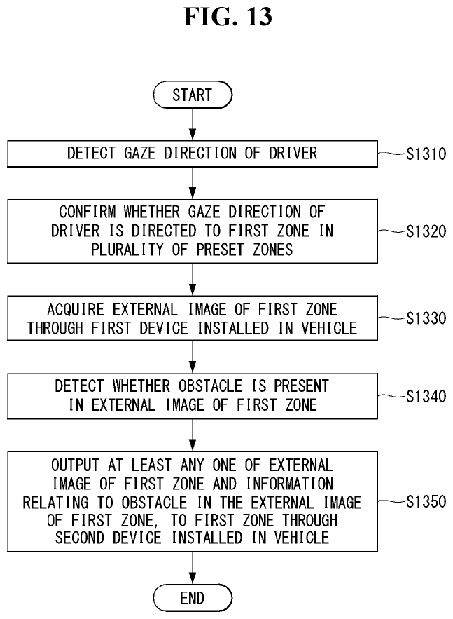

FIG. 13 shows a flowchart of a vehicle external information output method proposed in the present disclosure.

### DETAILED DESCRIPTION OF THE EMBODIMENTS

In what follows, embodiments disclosed in this document will be described in detail with reference to appended drawings, where the same or similar constituent elements are given the same reference number irrespective of their drawing symbols, and repeated descriptions thereof will be omitted. In describing an embodiment disclosed in the present specification, if a constituting element is said to be “connected” or “attached” to other constituting element, it should be understood that the former may be connected or attached directly to the other constituting element, but there may be a case in which another constituting element is present between the two constituting elements.

Also, in describing an embodiment disclosed in the present document, if it is determined that a detailed description of a related art incorporated herein unnecessarily obscure the gist of the embodiment, the detailed description thereof will be omitted. Also, it should be understood that the appended drawings are intended only to help understand embodiments disclosed in the present document and do not limit the technical principles and scope of the present invention; rather, it should be understood that the appended drawings include all of the modifications, equivalents or substitutes described by the technical principles and belonging to the technical scope of the present invention.

[5G Scenario]

The three main requirement areas in the 5G system are (1) enhanced Mobile Broadband (eMBB) area, (2) massive Machine Type Communication (mMTC) area, and (3) Ultra-Reliable and Low Latency Communication (URLLC) area. Some use case may require a plurality of areas for optimization, but other use case may focus only one Key Performance Indicator (KPI). The 5G system supports various use cases in a flexible and reliable manner.

eMBB far surpasses the basic mobile Internet access, supports various interactive works, and covers media and entertainment applications in the cloud computing or augmented reality environment. Data is one of core driving elements of the 5G system, which is so abundant that for the first time, the voice-only service may disappear. In the 5G, voice is expected to be handled simply by an application program using a data connection provided by the communication system. Primary causes of increased volume of traffic are increase of content size and increase of the number of applications requiring a high data transfer rate. Streaming service (audio and video), interactive video, and mobile Internet connection will be more heavily used as more and more devices are connected to the Internet. These application programs require always-on connectivity to push real-time information and notifications to the user. Cloud-based storage and applications are growing rapidly in the mobile communication platforms, which may be applied to both of business and entertainment uses. And the cloud-based storage is a special use case that drives growth of uplink data transfer rate. The 5G is also used for cloud-based remote works and requires a much shorter end-to-end latency to ensure excellent user experience when a tactile interface is used. Entertainment, for example, cloud-based game and video streaming, is another core element that strengthens the requirement for mobile broadband capability. Entertainment is essential for smartphones and tablets in any place including a high mobility environment such as a train, car, and plane. Another use case is augmented reality for entertainment and information search. Here, augmented reality requires very low latency and instantaneous data transfer.

Also, one of highly expected 5G use cases is the function that connects embedded sensors seamlessly in every possible area, namely the use case based on mMTC. Up to 2020, the number of potential IoT devices is expected to reach 20.4 billion. Industrial IoT is one of key areas where the 5G performs a primary role to maintain infrastructure for smart city, asset tracking, smart utility, agriculture and security.

URLLC includes new services which may transform industry through ultra-reliable/ultra-low latency links, such as remote control of major infrastructure and self-driving cars. The level of reliability and latency are essential for smart grid control, industry automation, robotics, and drone control and coordination.

Next, a plurality of use cases will be described in more detail. The 5G may complement Fiber-To-The-Home (FTTH) and cable-based broadband (or DOCSIS) as a means to provide a stream estimated to occupy hundreds of megabits per second up to gigabits per second. This fast speed is required not only for virtual reality and augmented reality but also for transferring video with a resolution more than 4K (6K, 8K or more). VR and AR applications almost always include immersive sports games. Specific application programs may require a special network configuration. For example, in the case of VR game, to minimize latency, game service providers may have to integrate a core server with the edge network service of the network operator.

Automobiles are expected to be a new important driving force for the 5G system together with various use cases of mobile communication for vehicles. For example, entertainment for passengers requires high capacity and high mobile broadband at the same time. This is so because users continue to expect a high-quality connection irrespective of their location and moving speed. Another use case in the automotive field is an augmented reality dashboard. The augmented reality dashboard overlays information, which is a perception result of an object in the dark and contains distance to the object and object motion, on what is seen through the front window. In a future, a wireless module enables communication among vehicles, information exchange between a vehicle and supporting infrastructure, and information exchange among a vehicle and other connected devices (for example, devices carried by a pedestrian). A safety system guides alternative courses of driving so that a driver may drive his or her vehicle more safely and to reduce the risk of accident. The next step will be a remotely driven or self-driven vehicle. This step requires highly reliable and highly fast communication between different self-driving vehicles and between a self-driving vehicle and infrastructure. In the future, it is expected that a self-driving vehicle takes care of all of the driving activities while a human driver focuses on dealing with an abnormal driving situation that the self-driving vehicle is unable to recognize. Technical requirements of a self-driving vehicle demand ultra-low latency and ultra-fast reliability up to the level that traffic safety may not be reached by human drivers.

The smart city and smart home, which are regarded as essential to realize a smart society, will be embedded into a high-density wireless sensor network. Distributed networks comprising intelligent sensors may identify conditions for cost-efficient and energy-efficient conditions for maintaining cities and homes. A similar configuration may be applied for each home. Temperature sensors, window and heating controllers, anti-theft alarm devices, and home appliances will be all connected wirelessly. Many of these sensors typified with a low data transfer rate, low power, and low cost. However, for example, real-time HD video may require specific types of devices for the purpose of surveillance.

As consumption and distribution of energy including heat or gas is being highly distributed, automated control of a distributed sensor network is required. A smart grid collects information and interconnect sensors by using digital information and communication technologies so that the distributed sensor network operates according to the collected information. Since the information may include behaviors of energy suppliers and consumers, the smart grid may help improving distribution of fuels such as electricity in terms of efficiency, reliability, economics, production sustainability, and automation. The smart grid may be regarded as a different type of sensor network with a low latency.

The health-care sector has many application programs that may benefit from mobile communication. A communication system may support telemedicine providing a clinical care from a distance. Telemedicine may help reduce barriers to distance and improve access to medical services that are not readily available in remote rural areas. It may also be used to save lives in critical medical and emergency situations. A wireless sensor network based on mobile communication may provide remote monitoring and sensors for parameters such as the heart rate and blood pressure.

Wireless and mobile communication are becoming increasingly important for industrial applications. Cable wiring requires high installation and maintenance costs. Therefore, replacement of cables with reconfigurable wireless links is an attractive opportunity for many industrial applications. However, to exploit the opportunity, the wireless connection is required to function with a latency similar to that in the cable connection, to be reliable and of large capacity, and to be managed in a simple manner. Low latency and very low error probability are new requirements that lead to the introduction of the 5G system.

Logistics and freight tracking are important use cases of mobile communication, which require tracking of an inventory and packages from any place by using location-based information system. The use of logistics and freight tracking typically requires a low data rate but requires large-scale and reliable location information.

The present invention to be described below may be implemented by combining or modifying the respective embodiments to satisfy the aforementioned requirements of the 5G system.

FIG. 1 illustrates one embodiment of an AI device. Referring to FIG. 1, in the AI system, at least one or more of an AI server 16, robot 11, self-driving vehicle 12, XR device 13, smartphone 14, or home appliance 15 are connected to a cloud network 10. Here, the robot 11, self-driving vehicle 12, XR device 13, smartphone 14, or home appliance 15 to which the AI technology has been applied may be referred to as an AI device (11 to 15).

The cloud network 10 may comprise part of the cloud computing infrastructure or refer to a network existing in the cloud computing infrastructure. Here, the cloud network 10 may be constructed by using the 3G network, 4G or Long Term Evolution (LTE) network, or 5G network.

In other words, individual devices (11 to 16) constituting the AI system may be connected to each other through the cloud network 10. In particular, each individual device (11 to 16) may communicate with each other through the eNB but may communicate directly to each other without relying on the eNB.

The AI server 16 may include a server performing AI processing and a server performing computations on big data. The AI server 16 may be connected to at least one or more of the robot 11, self-driving vehicle 12, XR device 13, smartphone 14, or home appliance 15, which are AI devices constituting the AI system, through the cloud network 10 and may help at least part of AI processing conducted in the connected AI devices (11 to 15).

At this time, the AI server 16 may teach the artificial neural network according to a machine learning algorithm on behalf of the AI device (11 to 15), directly store the learning model, or transmit the learning model to the AI device (11 to 15). At this time, the AI server 16 may receive input data from the AI device (11 to 15), infer a result value from the received input data by using the learning model, generate a response or control command based on the inferred result value, and transmit the generated response or control command to the AI device (11 to 15).

Similarly, the AI device (11 to 15) may infer a result value from the input data by employing the learning model directly and generate a response or control command based on the inferred result value.

<AI+Robot>

By employing the AI technology, the robot 11 may be implemented as a guide robot, transport robot, cleaning robot, wearable robot, entertainment robot, pet robot, or unmanned flying robot. The robot 11 may include a robot control module for controlling its motion, where the robot control module may correspond to a software module or a chip which implements the software module in the form of a hardware device.

The robot 11 may obtain status information of the robot 11, detect (recognize) the surroundings and objects, generate map data, determine a travel path and navigation plan, determine a response to user interaction, or determine motion by using sensor information obtained from various types of sensors. Here, the robot 11 may use sensor information obtained from at least one or more sensors among lidar, radar, and camera to determine a travel path and navigation plan.

The robot 11 may perform the operations above by using a learning model built on at least one or more artificial neural networks. For example, the robot 11 may recognize the surroundings and objects by using the learning model and determine its motion by using the recognized surroundings or object information. Here, the learning model may be the one trained by the robot 11 itself or trained by an external device such as the AI server 16.

At this time, the robot 11 may perform the operation by generating a result by employing the learning model directly but also perform the operation by transmitting sensor information to an external device such as the AI server 16 and receiving a result generated accordingly. The robot 11 may determine a travel path and navigation plan by using at least one or more of object information detected from the map data and sensor information or object information obtained from an external device and navigate according to the determined travel path and navigation plan by controlling its locomotion platform.

Map data may include object identification information about various objects disposed in the space in which the robot 11 navigates. For example, the map data may include object identification information about static objects such as wall and doors and movable objects such as a flowerpot and a desk. And the object identification information may include the name, type, distance, location, and so on.

Also, the robot 11 may perform the operation or navigate the space by controlling its locomotion platform based on the control/interaction of the user. At this time, the robot 11 may obtain intention information of the interaction due to the user's motion or voice command and perform an operation by determining a response based on the obtained intention information.

<AI+Autonomous Navigation>

By employing the AI technology, the self-driving vehicle 12 may be implemented as a mobile robot, unmanned ground vehicle, or unmanned aerial vehicle. The self-driving vehicle 12 may include an autonomous navigation module for controlling its autonomous navigation function, where the autonomous navigation control module may correspond to a software module or a chip which implements the software module in the form of a hardware device. The autonomous navigation control module may be installed inside the self-driving vehicle 12 as a constituting element thereof or may be installed outside the self-driving vehicle 12 as a separate hardware component.

The self-driving vehicle 12 may obtain status information of the self-driving vehicle 12, detect (recognize) the surroundings and objects, generate map data, determine a travel path and navigation plan, or determine motion by using sensor information obtained from various types of sensors. Like the robot 11, the self-driving vehicle 12 may use sensor information obtained from at least one or more sensors among lidar, radar, and camera to determine a travel path and navigation plan.

In particular, the self-driving vehicle 12 may recognize an occluded area or an area extending over a predetermined distance or objects located across the area by collecting sensor information from external devices or receive recognized information directly from the external devices.

The self-driving vehicle 12 may perform the operations above by using a learning model built on at least one or more artificial neural networks. For example, the self-driving vehicle 12 may recognize the surroundings and objects by using the learning model and determine its navigation route by using the recognized surroundings or object information. Here, the learning model may be the one trained by the self-driving vehicle 12 itself or trained by an external device such as the AI server 16.

At this time, the self-driving vehicle 12 may perform the operation by generating a result by employing the learning model directly but also perform the operation by transmitting sensor information to an external device such as the AI server 16 and receiving a result generated accordingly. The self-driving vehicle 12 may determine a travel path and navigation plan by using at least one or more of object information detected from the map data and sensor information or object information obtained from an external device and navigate according to the determined travel path and navigation plan by controlling its driving platform.

Map data may include object identification information about various objects disposed in the space (for example, road) in which the self-driving vehicle 12 navigates. For example, the map data may include object identification information about static objects such as streetlights, rocks and buildings and movable objects such as vehicles and pedestrians. And the object identification information may include the name, type, distance, location, and so on.

Also, the self-driving vehicle 12 may perform the operation or navigate the space by controlling its driving platform based on the control/interaction of the user. At this time, the self-driving vehicle 12 may obtain intention information of the interaction due to the user's motion or voice command and perform an operation by determining a response based on the obtained intention information.

<AI+XR>

By employing the AI technology, the XR device 13 may be implemented as a Head-Mounted Display (HMD), Head-Up Display (HUD) installed at the vehicle, TV, mobile phone, smartphone, computer, wearable device, home appliance, digital signage, vehicle, robot with a fixed platform, or mobile robot. The XR device 13 may obtain information about the surroundings or physical objects by generating position and attribute data about 3D points by analyzing 3D point cloud or image data acquired from various sensors or external devices and output objects in the form of XR objects by rendering the objects for display.

The XR device 13 may perform the operations above by using a learning model built on at least one or more artificial neural networks. For example, the XR device 13 may recognize physical objects from 3D point cloud or image data by using the learning model and provide information corresponding to the recognized physical objects. Here, the learning model may be the one trained by the XR device 13 itself or trained by an external device such as the AI server 16.

At this time, the XR device 13 may perform the operation by generating a result by employing the learning model directly but also perform the operation by transmitting sensor information to an external device such as the AI server 16 and receiving a result generated accordingly.

<AI+robot+Autonomous Navigation>

By employing the AI and autonomous navigation technologies, the robot 11 may be implemented as a guide robot, transport robot, cleaning robot, wearable robot, entertainment robot, pet robot, or unmanned flying robot. The robot 11 employing the AI and autonomous navigation technologies may correspond to a robot itself having an autonomous navigation function or a robot 11 interacting with the self-driving vehicle 12.

The robot 11 having the autonomous navigation function may correspond collectively to the devices which may move autonomously along a given path without control of the user or which may move by determining its path autonomously.

The robot 11 and the self-driving vehicle 12 having the autonomous navigation function may use a common sensing method to determine one or more of the travel path or navigation plan. For example, the robot 11 and the self-driving vehicle 12 having the autonomous navigation function may determine one or more of the travel path or navigation plan by using the information sensed through lidar, radar, and camera.

The robot 11 interacting with the self-driving vehicle 12, which exists separately from the self-driving vehicle 12, may be associated with the autonomous navigation function inside or outside the self-driving vehicle 12 or perform an operation associated with the user riding the self-driving vehicle 12. At this time, the robot 11 interacting with the self-driving vehicle 12 may obtain sensor information in place of the self-driving vehicle 12 and provide the sensed information to the self-driving vehicle 12; or may control or assist the autonomous navigation function of the self-driving vehicle 12 by obtaining sensor information, generating information of the surroundings or object information, and providing the generated information to the self- driving vehicle 12.

Also, the robot 11 interacting with the self-driving vehicle 12 may control the function of the self-driving vehicle 12 by monitoring the user riding the self-driving vehicle 12 or through interaction with the user. For example, if it is determined that the driver is drowsy, the robot 11 may activate the autonomous navigation function of the self-driving vehicle 12 or assist the control of the driving platform of the self-driving vehicle 12. Here, the function of the self-driving vehicle 12 controlled by the robot 12 may include not only the autonomous navigation function but also the navigation system installed inside the self-driving vehicle 12 or the function provided by the audio system of the self-driving vehicle 12.

Also, the robot 11 interacting with the self-driving vehicle 12 may provide information to the self-driving vehicle 12 or assist functions of the self-driving vehicle 12 from the outside of the self-driving vehicle 12. For example, the robot 11 may provide traffic information including traffic sign information to the self-driving vehicle 12 like a smart traffic light or may automatically connect an electric charger to the charging port by interacting with the self- driving vehicle 12 like an automatic electric charger of the electric vehicle.

<AI+Robot+XR>

By employing the AI technology, the robot 11 may be implemented as a guide robot, transport robot, cleaning robot, wearable robot, entertainment robot, pet robot, or unmanned flying robot. The robot 11 employing the XR technology may correspond to a robot which acts as a control/interaction target in the XR image. In this case, the robot 11 may be distinguished from the XR device 13, both of which may operate in conjunction with each other.

If the robot 11, which acts as a control/interaction target in the XR image, obtains sensor information from the sensors including a camera, the robot 11 or XR device 13 may generate an XR image based on the sensor information, and the XR device 13 may output the generated XR image. And the robot 11 may operate based on the control signal received through the XR device 13 or based on the interaction with the user.

For example, the user may check the XR image corresponding to the viewpoint of the robot 11 associated remotely through an external device such as the XR device 13, modify the navigation path of the robot 11 through interaction, control the operation or navigation of the robot 11, or check the information of nearby objects.

<AI+Autonomous Navigation+XR>

By employing the AI and XR technologies, the self-driving vehicle 12 may be implemented as a mobile robot, unmanned ground vehicle, or unmanned aerial vehicle. The self-driving vehicle 12 employing the XR technology may correspond to a self-driving vehicle having a means for providing XR images or a self-driving vehicle which acts as a control/interaction target in the XR image. In particular, the self-driving vehicle 12 which acts as a control/interaction target in the XR image may be distinguished from the XR device 13, both of which may operate in conjunction with each other.

The self-driving vehicle 12 having a means for providing XR images may obtain sensor information from sensors including a camera and output XR images generated based on the sensor information obtained. For example, by displaying an XR image through HUD, the self-driving vehicle 12 may provide XR images corresponding to physical objects or image objects to the passenger.

At this time, if an XR object is output on the HUD, at least part of the XR object may be output so as to be overlapped with the physical object at which the passenger gazes. On the other hand, if an XR object is output on a display installed inside the self-driving vehicle 12, at least part of the XR object may be output so as to be overlapped with an image object. For example, the self-driving vehicle 12 may output XR objects corresponding to the objects such as roads, other vehicles, traffic lights, traffic signs, bicycles, pedestrians, and buildings.

If the self-driving vehicle 12, which acts as a control/interaction target in the XR image, obtains sensor information from the sensors including a camera, the self-driving vehicle 12 or XR device 13 may generate an XR image based on the sensor information, and the XR device 13 may output the generated XR image. And the self-driving vehicle 12 may operate based on the control signal received through an external device such as the XR device 13 or based on the interaction with the user.

[Extended Reality Technology]eXtended Reality (XR) refers to all of Virtual Reality (VR), Augmented Reality (AR), and Mixed Reality (MR). The VR technology provides objects or backgrounds of the real world only in the form of CG images, AR technology provides virtual CG images overlaid on the physical object images, and MR technology employs computer graphics technology to mix and merge virtual objects with the real world.

MR technology is similar to AR technology in a sense that physical objects are displayed together with virtual objects. However, while virtual objects supplement physical objects in the AR, virtual and physical objects co-exist as equivalents in the MR. The XR technology may be applied to Head-Mounted Display (HMD), Head-Up Display (HUD), mobile phone, tablet PC, laptop computer, desktop computer, TV, digital signage, and so on, where a device employing the XR technology may be called an XR device.

Hereinafter, 5G communication (5th generation mobile communication) required by an apparatus requiring AI processed information and/or an AI processor will be described through paragraphs A through G.

A. Example of Block Diagram of UE and 5G Network

FIG. 2 is a block diagram of a wireless communication system to which methods proposed in the disclosure are applicable. Referring to FIG. 2, a device (AI device) including an AI module is defined as a first communication device (910 of FIG. 2), and a processor 911 can perform detailed autonomous operations.

A 5G network including device (AI server) communicating with the AI device is defined as a second communication device (920 of FIG. 2), and a processor 921 can perform detailed autonomous operations. The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like. For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, aVR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 2, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

FIG. 3 is a diagram showing an example of a signal transmission/reception method in a wireless communication system. Referring to FIG. 3, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 3. The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described. SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 3. A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam. The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the OSI-S SB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS- ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time- frequency resources according to timeFrequency Sect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI using 5G Communication

FIG. 4 shows an example of basic operations of a UE and a 5G network in a 5G communication system.

The UE transmits specific information to the 5G network (S1). The 5G network may perform 5G processing related to the specific information (S2). Here, the 5G processing may include AI processing. And the 5G network may transmit response including AI processing result to UE(S3).

G. Applied operations between UE and 5G network in 5G communication system Hereinafter, the operation using 5G communication will be described in more detail with reference to wireless communication technology (BM procedure, URLLC, mMTC, etc.) described in FIGS. 2 and 3.

First, a basic procedure of an applied operation to which a method proposed by the present invention which will be described later and eMBB of 5G communication are applied will be described.

As in steps S1 and S3 of FIG. 4, the UE performs an initial access procedure and a random access procedure with the 5G network prior to step S1 of FIG. 4 in order to transmit/receive signals, information and the like to/from the 5G network.

More specifically, the UE performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the UE receives a signal from the 5G network.

In addition, the UE performs a random access procedure with the 5G network for UL synchronization acquisition and/or UL transmission. The 5G network can transmit, to the UE, a UL grant for scheduling transmission of specific information. Accordingly, the UE transmits the specific information to the 5G network on the basis of the UL grant. In addition, the 5G network transmits, to the UE, a DL grant for scheduling transmission of 5G processing results with respect to the specific information. Accordingly, the 5G network can transmit, to the UE, information (or a signal) related to remote control on the basis of the DL grant.

Next, a basic procedure of an applied operation to which a method proposed by the present invention which will be described later and URLLC of 5G communication are applied will be described.

As described above, an UE can receive DownlinkPreemption IE from the 5G network after the UE performs an initial access procedure and/or a random access procedure with the 5G network. Then, the UE receives DCI format 2_1 including a preemption indication from the 5G network on the basis of DownlinkPreemption IE. The UE does not perform (or expect or assume) reception of eMBB data in resources (PRBs and/or OFDM symbols) indicated by the preemption indication. Thereafter, when the UE needs to transmit specific information, the UE can receive a UL grant from the 5G network.

Next, a basic procedure of an applied operation to which a method proposed by the present invention which will be described later and mMTC of 5G communication are applied will be described.

Description will focus on parts in the steps of FIG. 4 which are changed according to application of mMTC.

In step S1 of FIG. 4, the UE receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the UE transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

FIG. 5 shows a vehicle according to an embodiment of the present invention. Referring to FIG. 5, a vehicle 100 according to an embodiment of the present invention is defined as transportation means for traveling on a road or a track. The vehicle 100 is a concept including an automobile, a train, and a motorcycle. The vehicle 100 may be a concept including all of an internal combustion engine vehicle provided with an engine as a power source, a hybrid vehicle provided with an engine and an electric motor as power sources, and an electric vehicle provided with an electric motor as a power source. The vehicle 100 may be a vehicle owned by an individual. The vehicle 100 may be a shared vehicle. The vehicle 100 may be an autonomous vehicle.

FIG. 6 is a block diagram of an AI apparatus 200 according to an embodiment of the present invention. The AI apparatus 200 may include an electronic device including an AI module capable of performing AI processing or a server including the AI module. In addition, the AI apparatus 200 may be included in at least a configuration member of the vehicle 100 illustrated in FIG. 5 so as to at least partially perform the AI processing together.

The AI processing may include all operations relating to controlling of the vehicle 100 shown in FIG. 5. For example, the autonomous vehicle may perform operations for processing/determination and control signal generation by performing the AI process on sensing data or driver data. In addition, for example, the autonomous vehicle may perform autonomous traveling control by performing the AI processing on data acquired through interaction with other electronic devices included in the vehicle.

The AI apparatus 200 may include an AI processor 21, a memory 25, and/ or a communication unit 27. The AI device 200 is a computing apparatus capable of learning a neural network, and may be embodied as various electronic devices such as a server, a desktop PC, a notebook PC, and a tablet PC.

The AI processor 21 may learn the neural network by using a program stored in the memory 25. In particular, the AI processor 21 may learn the neural network for recognizing terminal related data. Here, the neural network for recognizing the terminal related data may be designed to simulate a human brain structure on a computer, and may include a plurality of weighted network nodes which simulate neurons of a human neural network. The plurality of network modes may transmit and receive data in accordance with a linkage relationship so that the neurons simulate a synaptic activity of the neurons which transmit and receive signals through synapses. Here, the neural network may include a deep learning model developed from a neural network model. In the deep learning model, the plurality of network nodes may be located at mutually different layers, and may transmit and receive data in accordance with a convolutional linkage relationship. Examples of the neural network model include various deep learning techniques such as deep neural networks (DNN), convolutional deep neural networks (CNN), Recurrent Boltzmann machines (RNN), Restricted Boltzmann Machines (RBM), and deep belief networks (DBN), and Deep Q-Networks, and are applicable to a field such as computer vision, speech recognition, natural language processing, and voice/signal processing.

Meanwhile, the processor that fulfills the above-described functions may be a general purpose processor (for example, a CPU), but may be an AI dedicated processor (for example, a GPU) for artificial intelligence learning. The memory 25 may store various programs and data which are required for operations of the AI apparatus 200. The memory 25 may be embodied as a nonvolatile memory, a volatile memory, a flash-memory, a hard disk drive (HDD), or a solid state drive (SDD). The memory 25 may be accessed by the AI processor 21. The AI processor 21 may perform data reading/writing/correcting/deleting/updating. In addition, the memory 25 may store the neural network model (for example, a deep learning model 26) generated through a learning algorithm for data classification/recognition according to an embodiment of the present invention.

Meanwhile, the AI processor 21 may include a data learning unit 22 for learning the neural network for data classification/recognition. The data learning unit 22 may learn a criterion on what learning data to use in order to determine the data classification/recognition and how to classify and recognize the data by using the learning data. The data learning unit 22 may learn the deep learning model by acquiring the learning data to be used for learning and applying the acquired learning data to the deep learning model.

The data learning unit 22 may be manufactured in a form of at least one hardware chip, and may be mounted on the AI apparatus 200. For example, the data learning unit 22 may be manufactured in a form of a dedicated hardware chip for artificial intelligence (AI), or may be manufactured as a portion of a central processing unit (CPU) or a graphical processing unit (GPU) so as to be mounted on the AI apparatus 200. In addition, the data learning unit 22 may be embodied as a software module. In a case where the data learning unit 22 is embodied as the software module (or a program module including instructions), the software module may be stored in non-transitory computer readable media. In this case, at least one software module may be provided by an operating system (OS) or by an application.

The data learning unit 22 may include a learning data acquisition unit 23 and a model learning unit 24. The learning data acquisition unit 23 may acquire learning data required for the neural network model for classifying and recognizing the data. For example, the learning data acquisition unit 23 may acquire vehicle data and/or sample data for being input to the neural network model as the learning data.

The model learning unit 24 may learn to have a determination criterion about how the neural network model classifies predetermined data by using the acquired learning data. In this case, the model learning unit 24 may learn the neural network model through supervised learning using at least some of the learning data as the determination criterion. Alternatively, the model learning unit 24 may learn the neural network model through unsupervised learning for finding the determination criterion by using the learning data without any guidance and through self-learning. In addition, the model learning unit 24 may learn the neural network model through reinforcement learning by using a feedback on whether a situation determination result obtained by the learning is correct. In addition, the model learning unit 24 may learn the neural network model by using a learning algorithm including an error back- propagation method or a gradient decent method.

If the neural network model is learned, the model learning unit 24 may store the learned neural network model in a memory. The model learning unit 24 may store the learned neural network model in a memory of a server linked with the AI apparatus 200 through a wired or wireless network.

The data learning unit 22 may further include a learning data preprocessor (not shown) and a learning data selection unit (not shown) in order to improve an analysis result of the recognition model or in order to save a resource or time required for generating the recognition model. The learning data preprocessing unit may preprocess the acquired data so that the acquired data is used in learning for situation determination. For example, the learning data preprocessing unit may process the acquired data into a preset format so that the model learning unit 24 uses the learning data acquired to learn image recognition.

In addition, the learning data selection unit may select data required for learning from the learning data acquired by the learning data acquisition unit 23 or the learning data preprocessed by the learning data preprocessing unit. The selected learning data may be provided for the model learning unit 24. For example, the learning data selection unit may select only data for an object included in a specific region as the learning data by detecting only the specific region of the image acquired through the camera of the vehicle. In addition, the data learning unit 22 may further include a model evaluation unit (not shown) in order to improve the analysis result of the neural network model.

The model evaluation unit may input the evaluation data to the neural network model. In a case where the analysis result output from the evaluation data does not satisfy a predetermined criterion, the model evaluation unit 22 may cause the model learning unit 22 to learn the learning data again. In this case, the evaluation data may be predefined data for evaluating the recognition model. For example, the model evaluation unit may evaluate that the predetermined criterion is not satisfied in a case where the number or ratio of the evaluation data having inaccurate analysis result exceeds a preset threshold, based on the analysis results of the learned recognition model for the evaluation data.

The communication unit 27 may transmit the AI processing results obtained by the AI processor 21 to an external electronic device. Here, the external electronic device may be defined as an autonomous vehicle. In addition, the AI apparatus 200 may be defined as another vehicle or a 5G network which communicates with the autonomous driving module vehicle. Meanwhile, the AI apparatus 200 may be embodied by being functionally embedded in an autonomous driving module included in the vehicle. In addition, the 5G network may include a server or a module which performs autonomous driving-related control.

Meanwhile, the AI apparatus 200 shown in FIG. 6 has been described by being functionally divided into the AI processor 21, the memory 25, and the communication unit 27. However, the above-described configuration elements may be integrated into one module, and the module may be referred to as an AI module.

Since vehicles have been recently developed and widely distributed, most households actually own one or more vehicles. Meanwhile, many driving-related accidents happen due to the widely distributed vehicles. In particular, may accidents happen since a visual field of the driver is blocked by a vehicle body (pillar, door, ceiling, or bonnet). That is, the driver feels uncomfortable in driving the vehicle due to a blind spot in which the visual field is not secured by the vehicle body, thereby causing a problem in that the related accidents frequently happen.

In addition, in order to secure the visual field of the blind spot, to the driver is provided with the visual field by using glass and a head up display (HUD) in the visual field which is blocked by the vehicle body. However, there are the following problems. The driver is likely to feel different depending on a head position or the visual field of the driver. Mutually different techniques are required depending on parts of the vehicle body (pillar, door, ceiling, or bonnet). The manufacturing cost is expensive. In a case where the vehicle body is replaced with mirror, glass, or other devices, rigidity of the vehicle is weakened.

In this regard, in order to solve the above-described inconveniences and problems, the present disclosure proposes a vehicle external information providing method which enables the driver to conveniently enjoy the vehicle driving by outputting image information relating to the blind spot and providing the driver with the image information.

FIG. 7 shows a block diagram of the vehicle external information output apparatus proposed in the present disclosure. Referring to FIG. 7, the vehicle external information output apparatus may be configured to include a driver status monitoring (DSM) camera 710, a first device 720, a second device 730, and a processor 740.

The DSM camera 710 may recognize a state of the driver by measuring a pupil movement and an eyelid response of the driver. In addition, DSM camera 710 may detect where a gaze of the driver is directed by tracking/tracing the gaze of the driver. In this case, the DSM camera 710 may be installed inside the vehicle.

The first device 720 captures the external image of the vehicle, and acquires the external image. The first device 720 may be installed inside/outside the vehicle, and may have a plurality of cameras for capturing images on a front side, a rear side, and a lateral side of the vehicle.

The first device 720 may be interlocked with the DSM camera 710. If the DSM camera 710 determines that the gaze of the user is directed to a specific zone, the first device 720 may be informed that the gaze of the user is directed to the specific zone. The first device 720 receiving the information may transmit the external image of the vehicle relating to the specific zone, to the second device 730.

In addition, the first device 720 may detect whether there is preset information in the captured external image, and may transmit the detected information to the second device 730. In this case, the preset information may mean an obstacle (for example, an object, a street lamp, or a person) existing outside the vehicle, which is useful information for the vehicle driving.

In addition, a size of the obstacle, a distance between the vehicle and the obstacle, and a type of the obstacle may be analyzed, and information relating to the obstacle may be transmitted to the second device 730. Artificial intelligence may be utilized to analyze the size or the type of the obstacle, and deep learning may be utilized. In this case, the preset information may be expressed as the external information.

In addition, in a case where the DSM camera 710 traces a gaze movement of the driver and the gaze of the driver moves from a specific first zone to a second zone, the DSM camera 710 may notify the first device 720 of the movement. The first device 720 may transmit the external image relating to the second zone to the second device 730, and may output/provide the external image relating to the second zone to the driver.

The second device 730 receives the external image of the vehicle from the first device 720, and outputs the received external image of the vehicle to the driver. The second device 730 may be installed inside the vehicle. The second device 730 may be smart glasses 730a, a projector 730b, an external image display device 730d, and an indicator 730c.

That is, the second device 730 may be interlocked with the first device 720 so as to receive and output the external image captured by the first device, and may output useful information for the vehicle driving. In this case, the external image and the useful information for the vehicle driving may be output to a specific zone to which the gaze of the driver is directed.

In addition, the above-described system is an embodiment for providing the driver with the external image of the vehicle by using the DSM camera 710, the first device 720, and the second device 730. In a case where the driver drives the vehicle rearward, the gaze of the driver is directed rearward of the vehicle. In this case, the DSM camera 710 detects the rearward movement, and transmits gaze information of the driver to the first device 720. The first device 720 transmits the external image relating to the rear side of the vehicle to the second device 730. In this manner, the second device 730 may provide the driver with the external image relating to the rear side of the vehicle.

That is, in a case where the driver drives the vehicle rearward, the visual fields behind the vehicle may be all output, and information (distance or type) relating to various obstacles located behind the vehicle may be output together. According to this configuration, the driver may be provided with the external image relating to the visual field blocked by the vehicle body, thereby achieving an advantageous effect in that driving inconvenience caused by the blind spot is minimized.

FIGS. 7 and 8 show an example in which vehicle external information is output through the smart glasses proposed in the present disclosure. In other words, FIG. 8 shows a method in which the second device 730 is the smart glasses 737a so as to provide the driver with the external information of the vehicle by using the smart glasses 737a interlocked with the first device 720. The smart glasses (730a) can provide the driver with augmented reality, and are one type of a wearable computer in a form of glasses equipped with a transparent function and a computer.

Referring to FIGS. 8 and 9, a method will be described in which the external image and the external information are output in a form of the augmented reality through the smart glasses. First, referring to FIG. 8, in order to output the external information of the vehicle, the DSM camera 710 and the first device 720 are installed in the vehicle. The driver may confirm the external information of the vehicle by wearing the smart glasses 730a.

In this case, an arrow in FIG. 8 represents a gaze direction of the driver, which indicates that the driver gazes at a pillar zone of the vehicle. In this case, FIG. 8 illustrates that the driver gazes at the pillar zone of the vehicle. However, the present invention is not limited thereto. The method proposed in the present disclosure may be applied to a case where the driver gazes at a remaining element excluding a transparent element in elements configuring an exterior of the vehicle, that is, an element in a zone where the gaze of the driver is blocked.

In the present disclosure, the element in the zone where the gaze of the driver is blocked may be represented by the vehicle body, and may be a pillar, a door, a ceiling, or a bonnet of the vehicle, for example. First, a state is assumed where the driver wears the smart glasses 730a.

The DSM camera 710 detects the gaze direction of the driver. At this time, the gaze direction of the driver may be directed to the vehicle body (pillar, door, ceiling, or bonnet) of the vehicle, which may mean that the visual field is hindered by the vehicle body. The vehicle body, that is, a zone hindering the outward visual field of the driver may be a preset zone. In this case, the DSM camera 710 may transmit information relating to the gaze direction of the driver to the first device 720 in a case where the gaze direction of the driver is directed to the preset zone.

The first device 720 may capture and acquire the external image of the vehicle relating to the gaze direction of the driver, and may transmit the external image to the smart glasses 730a. In this case, the first device 720 may detect whether the preset external image and information are present in the captured external image. The external information is information relating to various obstacles, and may include a type of the obstacles (person or street lamp), a moving speed of the obstacles, and a distance between the obstacles and the vehicle. In addition to the external image, the first device 720 may transmit the external information to the smart glasses 730a.

The smart glasses 737a receiving the external information may output at least any one of the external image and the external information. In this case, the external image and the external information may be output in the form of the augmented reality. That is, the visual field blocked by the pillar portion of the vehicle may be output in the form of the augmented reality, and the image and the information which correspond to the visual field blocked by the pillar of the vehicle, the door of the vehicle, the ceiling of the vehicle, or the bonnet of the vehicle may be output in the form of the augmented reality.

That is, a function of the augmented reality of the smart glasses 737a is utilized. In this manner, it is possible to embody a transparent pillar, a transparent door, a transparent ceiling, and a transparent bonnet by providing the visual field blocked by the pillar, the door, the ceiling, and the bonnet.

Specifically, referring to FIGS. 9(a), the external image corresponding to the visual field blocked by the pillar of the vehicle is output through the second device 730, for example, the smart glasses 730a. In this case, the information relating to the obstacle may be additionally output by detecting whether an obstacle 801 is present in the external image. FIG. 9(a) shows that the obstacle is a person, but the present invention is not limited thereto.

In addition, navigation information may be additionally output through the augmented reality. In order to additionally output the navigation information, the second device 730 may be interlocked with a navigation system installed in the vehicle so as to receive the information from the navigation system.

FIG. 9(b) shows, when the driver looks at the bonnet portion of the vehicle, image information corresponding to the field of view blocked by the bonnet portion of the vehicle is displayed on the smart glass 730a. In addition, the navigation information 802 may be additionally displayed.

As shown in FIG. 9(b) the bottom part blocked the bonnet portion of the vehicle, that is, the vehicle wheel, the road under the bonnet, may be displayed. Therefore, when there is an obstacle under the bonnet portion of the vehicle, the driver can identify the obstacle and the driver can more safety drive the vehicle.

Further, that navigation information 802, for example, a position of the vehicle, a speed of the vehicle, a destination of the vehicle, an arrival time to the destination, and a traveling route to the destination may be output through the augmented reality.

In addition, referring to FIG. 9(c), the external image corresponding to the visual field blocked by the door of the vehicle may be output. The external image in FIG. 9(c) is an image of a portion blocked by the door of the vehicle. The image including a person riding a bicycle may be output through the smart glasses 730a, as shown in FIG. 9(c). In this manner, the driver can more safely drive the vehicle.

Due to the visual field blocked by the vehicle body in the related art, vehicle accidents frequently happen without recognizing the external situation. However, in a case of using the method proposed in the present disclosure, the external image and external information relating to the blind spot can be acquired, thereby achieving an advantageous effect of reducing various accidents.

FIG. 10 shows an example in which the vehicle external information is output through the projector proposed in the present disclosure. In other words, FIG. 10 shows a method in which the second device 730 is the projector 730b so as to provide the driver with the external information of the vehicle by using the projector 730b.

The projector 730b may be included in the ceiling or an interior rear view mirror side of the vehicle. The external image of the vehicle may be output by being projected on the zone (for example, pillar, bonnet, ceiling, or door of the vehicle) where the visual field of the driver is blocked.

Referring to FIG. 10, an arrow indicates the gaze direction of the driver. In FIG. 10, the gaze of the driver is directed to the pillar of the vehicle. In this case, the DSM camera 710 may detect that the gaze of the driver is directed to the pillar of the vehicle, and may transmit the information relating to the gaze of the driver to the first device 720.

Then, the first device 720 may capture the external image on a side to which the gaze of the driver is directed, that is, the pillar side of the vehicle, and may transmit the captured image to the projector 730b. In this case, the first device 720 may detect whether the predetermined information is present in the external image on the pillar side of the vehicle. As described above, the driver may detect whether the obstacle is present in the external image, and may analyze/determine the information relating to the distance between the obstacle and the vehicle, the type of the obstacle, and the moving speed of the obstacle. The preset information may be additionally provided for the projector 730b. Thereafter, the projector 730b may output the external image and the preset information to the pillar of the vehicle, and may provide the driver with both of these.

Referring to FIG. 10, the obstacle 801 (for example, a pedestrian) may be present in a zone where the visual field is blocked by the pillar of the vehicle. The image of the pedestrian 801 may be output to the pillar of the vehicle. In other words, the external image corresponding to the visual field blocked by the vehicle body may be output to the vehicle body. In addition, as shown in FIG. 10, in a case of outputting the external image and the preset information by using the projector 730b, both of these may be directly output to the vehicle body (bonnet, door, ceiling, or pillar) of the vehicle without using a separate screen.

FIG. 11 shows an example of the vehicle external information output proposed in the present disclosure. In other words, FIG. 11 shows a method in which the second device 730 is the indicator 730c so as to provide the driver with the external information of the vehicle through the LED of the indicator 730c. In this case, the indicator 730c may be installed/attached to the vehicle body (for example, bonnet, door, ceiling, or pillar) of the vehicle so as to provide the driver with the information through LED light.

The indicator 730c described herein is a device using a meter or light so that the driver visibly confirms the presence or absence of a signal, a magnitude of the signal, and whether indicator 730c is operated. The indicator 730c may be a pick indicator such as a tape recorder using an LED plasma display, a signal indicator for a tuner, and a stereo indicator.

In other words, the indicator 730c in the present disclosure may detect whether the obstacle is present in the external image of the vehicle. If the obstacle is present, the LED light of the indicator 730c may output the information on whether the obstacle is present.

The processes of detecting the gaze direction of the driver through the DSM camera 710, capturing the external image in accordance with the gaze direction by the first device 720, and detecting the preset information in the captured external image are the same as the above-described processes.

However, in a case where the second device 730 is the indicator 730c, and in a case where the obstacle is present in the captured external image, the LED of the indicator 730c notifies the driver that the obstacle is present. That is, in a case where the obstacle is present in the preset information, the indicator 730c receiving the preset information from the first device 720 outputs the LED, and notifies the driver that the obstacle is present.

FIG. 12 shows an example of the vehicle external information output proposed in the present disclosure. In other words, FIG. 12 shows a method in which the second device 730 is the external image display device 730d and the external image display device 730d is attached/installed in the vehicle body so as to provide the driver with the external information of the vehicle.

The processes of detecting the gaze direction of the driver through the DSM camera 710, capturing the external image in accordance with the gaze direction by using the first device 720, and detecting the preset information in the captured external image are the same as the above-described processes. However, in a case where the second device 730 is the image display device 730d, the image display device 730d may be installed/attached to the vehicle body so as to output the external image and the external information.

That is, the portion where the visual field of the driver is blocked may be output by the image display device installed/attached to the vehicle body. Referring to FIG. 12, the image of the obstacle 801 (pedestrian) is output by the image display device. In a case of using the method proposed by the present disclosure, it is possible to provide the visual field having no blind spot and an open space. This method has an advantage in that one identical technique enables all of the vehicle bodies (pillar, door, ceiling, and bonnet) to fulfill a transparent function.

FIG. 13 is a flowchart showing a vehicle external information output method proposed in the present disclosure. First, the gaze direction of the driver is detected through a driver status monitoring (DSM) camera 710 installed in the vehicle (S1310). Thereafter, it is confirmed whether the gaze direction of the driver is directed to the first zone in a plurality of preset zones. In a case where the gaze direction of the driver is directed to the first zone, the external image of the first zone is acquired through the first device 720 (S1320 and S1330).

Then, it is detected whether the obstacle is present in the external image of the first zone (S1340). Then, at least any one of the external image of the first zone and the information relating to the obstacle in the external image of the first zone is output to the first zone through the second device 730 installed in the vehicle (S1350).

In this case, the plurality of preset zones may include a remaining element excluding a transparent element in the plurality of elements configuring the exterior of the vehicle, and may be a zone where the gaze of the driver is blocked. The second device 730 may be any one of the smart glasses 730a, the projector 730b, the external image display 730d, and the indicator 730c.

Meanwhile, in a case where the second device 730 is the smart glasses 730a, the external information of the vehicle may be output so that at least any one of the external image of the first zone and the information relating to the obstacle is output in the form of the augmented reality (AR). In this case, the plurality of preset zones may include at least one of the pillar, the door, the ceiling, and the bonnet of the vehicle.

Meanwhile, in a case where the second device 730 is the external image display 730d, the external image display 730d may be installed in at least any one of the plurality of preset zones of the vehicle. Meanwhile, in Step S1350, in a case where the second device 730 is the indicator 730c and the obstacle is present in the image of the first zone, the presence of the obstacle may be output through the LED of the indicator 730c.

In addition, the navigation information may be additionally output to the first zone. The navigation information may include at least any one of the position of the vehicle, the speed of the vehicle, the destination of the vehicle, and the arrival time to the destination.

In this case, the information relating to the obstacle in the external image of the first zone may be at least one information of the distance between the obstacle and the vehicle in the external image of the first zone, the moving speed of the obstacle in the external image of the first zone, and the type of the obstacle in the external image of the first zone.

In a case where the DSM camera 710 detects that the gaze direction of the driver moves from the first zone to the second zone, any one output of the external image of the first zone and the information relating to the obstacle in the external image of the first zone may be stopped. The external image of the second zone may be acquired through the first device 720. It may be detected whether the obstacle is present in the external image of the second zone. The second device 730 may output at least any one of the external image of the second zone and the information relating to the obstacle in the external image of the second zone.

In this case, the second zone may be one of the plurality of preset zones.

Referring to FIG. 7, a configuration of the vehicle external information output apparatus proposed in the present disclosure will be described in more detail. The vehicle external information output apparatus may include the driver status monitoring (DSM) camera 710 installed in the vehicle in order to detect the gaze direction of the driver, and the processor 740 functionally interlocked with the DSM camera 710.

The processor 740 may control the DSM camera to detect whether the gaze direction of the driver is directed to the first zone in the plurality of preset zones. In a case where the gaze direction of the driver is directed to the first zone, the processor 740 may control the first device 720 to acquire the external image of the first zone.

The processor 740 may control the first device 720 to detect whether the obstacle is present in the external image of the first zone. The processor may control the second device to output at least any one of the external image of the first zone and the information relating to the obstacle in the external image of the first zone, to the first zone.

The plurality of preset zones may include the remaining element excluding the transparent element in the plurality of elements configuring the exterior of the vehicle, and may be a zone where the gaze of the driver is blocked. The second device 730 may be any one of the smart glasses 730a, the projector 730b, the external image display 730d, and the indicator 730c.

Meanwhile, in a case where the second device 730 is the smart glasses 730a, the external information of the vehicle may be output so that at least any one of the external image of the first zone and the information relating to the obstacle is output in the form of the augmented reality (AR). The plurality of preset zones may be at least one of the pillar, the door, the ceiling, and the bonnet of the vehicle.

Meanwhile, the external image display 730d may be installed in at least any one of the plurality of preset zones of the vehicle. Meanwhile, in a case where the second device is the indicator 730c and the obstacle is present in the external image of the first zone, the presence of the obstacle may be output through the LED of the indicator 730c.

In addition, the second device may additionally output the navigation information to the first zone. The navigation information may include at least any one of the position of the vehicle, the speed of the vehicle, the destination of the vehicle, and the arrival time to the destination.

The information relating to the obstacle in the external image of the first zone may be at least one information of the distance between the obstacle and the vehicle in the external image of the first zone, the moving speed of the obstacle in the external image of the first zone, and the type of the obstacle in the external image of the first zone.

In a case where the DSM camera 710 detects that the gaze direction of the driver moves from the first zone to the second zone, the processor 740 may control the second device to stop at least any one output operation of the external image of the first zone and the information relating to the obstacle in the external image. In addition, the processor 740 may control the first device to acquire the external image of the second zone.

The processor 740 may control the first device 720 to detect whether the obstacle is present in the external image of the second zone. The processor 740 may control the second device 720 to output at least any one of the external image of the second zone and the information relating to the obstacle in the external image of the second zone, to the second zone. The second zone may be one of the plurality of preset zones.

Meanwhile, there may be provided an electronic device including a command for performing the vehicle external information providing method. Specifically, the electronic device may be configured to include one or more processors, a memory, and one or more programs. In this case, the one or more programs may be stored in the memory, and may be configured to be executed by the one or more processors, and may include the command for performing the vehicle external information providing method.

Certain embodiments or other embodiments according to the present invention described above are not exclusive or distinct from each another. Certain embodiments or other embodiments according to the present invention described above may share respective configurations or functions with each another, or may be combined with one another in the respective configurations or functions.

For example, it means that a configuration A described in certain embodiments and/or drawings and a configuration B described in other embodiments and/or drawings may be combined with each other. That is, even in a case where the combination between the configurations is not directly described, it means that the combination therebetween is available except in a case where the combination therebetween is not available.

The present invention described above may be embodied as a computer readable code on a program-recorded medium. A computer-readable medium includes all types of recording devices storing data which can be read by a computer system. Examples of the computer- readable medium include a hard disk drive (HDD), a solid state disk (SSD), a silicon disk drive (SDD), a ROM, a RAM, a CD-ROM, a magnetic tape, a floppy disk, and an optical data storage device. In addition, the examples also include those embodied in a form of a carrier wave (for example, transmission over the Internet). Accordingly, the detailed description above should not be construed as limiting in all aspects, and should be considered as illustrative. The scope of the present invention should be determined by reasonable interpretation of the appended claims, and all modifications within the equivalent scope of the present invention are included in the scope of the present invention.

Advantageous effects of a notification providing method according to an embodiment of the present invention are as follows. According to the present invention, it is possible to output information which is useful for vehicle driving in accordance with a visual field of a driver. In addition, the present invention enables the driver to conveniently enjoy the vehicle driving by outputting external image relating to a blind spot.

The advantageous effects obtainable according to the present invention are not limited to the above-described advantageous effects. Other advantageous effects which are not described above will be clearly understood by those skilled in the art from the description herein.

What is claimed is:

1. A vehicle external information output method comprising:
sensing a gaze direction of a driver through a driver status monitoring (DSM) camera installed in a vehicle;
acquiring an external image of a first zone among a plurality of present zones through a first device installed in the vehicle, when the gaze direction of the driver is directed to the first zone;
sensing whether an obstacle is present in the external image of the first zone; and
outputting information relating to the obstacle to the first zone through a second device installed in the vehicle,
wherein the plurality of preset zones include a plurality of elements configuring the vehicle that block the driver from seeing an outside of the vehicle.

2. The method of claim 1, wherein the plurality of preset elements configuring the vehicle include at least one of a pillar, a door, a ceiling, and a bonnet of the vehicle.

3. The method of claim 1, wherein the second device comprises an external image display installed in at least any one of the plurality of preset zones of the vehicle.

4. The method of claim 1, wherein the second device comprises an indicator having a light emitting diode outputting a presence of the obstacle.

5. The method of claim 1, further comprising:
outputting navigation information to the first zone.

6. The method of claim 5, wherein the navigation information includes at least any one of a position of the vehicle, a speed of the vehicle, a destination of the vehicle, and an arrival time to the destination of the vehicle.

7. The method of claim 1, wherein the information relating to the obstacle includes at least any information among a distance between the obstacle and the vehicle, a moving speed of the obstacle, and a type of the obstacle.

8. The method of claim 1, further comprising:
stop outputting the information relating to the obstacle when the DSM camera detects that the gaze direction of the driver moves from the first zone to a second zone;
acquiring an external image of the second zone through the first device;
sensing whether the obstacle is present in the external image of the second zone; and
outputting, to the second zone, information relating to the obstacle present in the external image of the second zone through the second device, wherein the second zone is one of the plurality of preset zones.

10. The method of claim 1, wherein the plurality of elements exclude a transparent element in the vehicle, and
wherein the second device is any one of a smart glasses, a projector, and an external image display.

11. The method of claim 1, wherein the second device is a smart glasses, and the information relating to the obstacle is output in a form of augmented reality (AR).

12. A vehicle external information output apparatus comprising:
a driver status monitoring (DSM) camera installed in a vehicle and configured to sense a gaze direction of a driver; and
a processor functionally linked with the DSM camera,
wherein the processor is configured to:
acquire an external image of a first zone among a plurality of present zones through a first device installed in the vehicle, when the gaze direction of the driver is directed to the first zone;
sense whether an obstacle is present in the external image of the first zone; and
output information relating to the obstacle to the first zone through a second device installed in the vehicle,
wherein the plurality of preset zones include a plurality of elements configuring the vehicle that block the driver from seeing an outside of the vehicle.

13. The apparatus of claim 12, wherein the plurality of elements configuring the vehicle include at least one of a pillar, a door, a ceiling, and a bonnet of the vehicle.

14. The apparatus of claim 12, wherein the second device comprises an external image display installed in at least any one of the plurality of preset zones of the vehicle.

15. The apparatus of claim 12, wherein the second device comprises an indicator having a light emitting diode outputting a presence of the obstacle.

16. The apparatus of claim 12, wherein the second device additionally outputs navigation information to the first zone, and
wherein the navigation information includes at least any one of a position of the vehicle, a speed of the vehicle, a destination of the vehicle, and an arrival time to the destination of the vehicle.

17. The apparatus of claim 12, wherein the information relating to the obstacle includes at least any information among a distance between the obstacle and the vehicle, a moving speed of the obstacle, and a type of the obstacle.

18. The apparatus of claim 12, wherein the processor is further configured to:
stop outputting the information relating to the obstacle when the DSM camera detects that the gaze direction of the driver moves from the first zone to a second zone;
acquire an external image of the second zone through the first device;
sense whether the obstacle is present in the external image of the second zone; and
output, to the second zone, information relating to the obstacle present in the external image of the second zone through the second device, and
wherein the second zone is one of the plurality of preset zones.

19. The apparatus of claim 12, wherein the plurality of elements exclude a transparent element in the vehicle,
wherein the second device is any one of a smart glasses, a projector, and an external image display, and
wherein when the second device is the smart glasses, the information relating to the obstacle is output in a form of augmented reality (AR).

20. An electronic device comprising:
one or more processors;
a memory; and
one or more programs,
wherein the one or more programs are stored in the memory, are executed by the one or more processors, and the one or more programs include a command for executing the method of claim 1.
